(19) United States
(12) Patent Application Publication
(10) Pub. No.: US 2025/0008867 A1
(43) Pub. Date: Jan. 9, 2025

(54) SYSTEMS AND METHODS FOR DISTRIBUTING SEED FROM DRUM SEEDER ASSEMBLIES AND TRANSFER APPARATUSES

(71) Applicants: Andrew Lee, Alpine, UT (US); Tavaci Technologies LLC, Alpine, UT (US)

(72) Inventors: Sean R. Peterson, Payson, UT (US); Andrew Lee, Alpine, UT (US)

(21) Appl. No.: 18/765,080

(22) Filed: Jul. 5, 2024

Related U.S. Application Data
(60) Provisional application No. 63/512,147, filed on Jul. 6, 2023.
(60) Provisional application No. 63/512,129, filed on Jul. 6, 2023.

(51) Int. Cl. A01C 7/12; A01C 7/10

(52) U.S. Cl. CPC A01C 7/123; A01C 7/105

(57) ABSTRACT

The present disclosure presents systems and related methods for distributing seed. One such system comprises a drum seeder assembly including a dispenser with an open top end for receiving seed, and an open bottom end for dispensing seed; a drum rotatably mounted beneath the dispenser, configured to receive seed through the open bottom end and distribute the seed as the drum rotates; and/or a transfer apparatus for delivering seed to the drum seeder assembly.

### CROSS-REFERENCE TO RELATED APPLICATION

This application claims priority to co-pending U.S. provisional application entitled, “Systems and Methods for Distributing Seed from Drum Seeder Assemblies and Transfer Apparatuses,” having application No. 63/512,147, filed Jul. 6, 2023, and U.S. provisional application entitled, “Systems and Methods for Providing a Modular Grow Pod,” having application No. 63/512,129, filed Jul. 6, 2023, each of which is entirely incorporated herein by reference.

### TECHNICAL FIELD

The present specification generally relates to systems and methods for distributing seed and, more specifically, systems and methods for a transfer apparatus to deliver seed to a drum seeder assembly prior to seed distribution.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

### SUMMARY

Embodiments of the present disclosure present systems and related methods for distributing seed. One such system comprises a drum seeder assembly including a dispenser with an open top end for receiving seed, and an open bottom end for dispensing seed; a drum rotatably mounted beneath the dispenser, configured to receive seed through the open bottom end and distribute the seed as the drum rotates; and/or a transfer apparatus for delivering seed to the drum seeder assembly.

Embodiments of the present disclosure also include a method comprising depositing seed into a transfer apparatus; transferring the seed from the transfer apparatus into a dispenser of a drum seeder assembly; and/or dispensing the seed through an open bottom end of the dispenser as a drum rotatably mounted beneath the dispenser rotates.

Embodiments of the present disclosure also include a drum seeder assembly comprising a dispenser with first and second end walls, first and second side walls, an open top end, and an open bottom end; and/or a drum with a cylindrical outer surface, rotatably mounted to the dispenser, configured to dispense seed through a gap formed between the drum and the open bottom end of the dispenser as the drum rotates.

In one or more aspects for systems and related methods and apparatuses for distributing seed, the dispenser further comprises a sensor proximate to the open top end for detecting an amount of seed within the dispenser; the drum seeder assembly further comprises a motor for rotating the drum and a controller configured to control a flow of seed into the dispenser by adjusting a speed of the drum; the transfer apparatus comprises a plurality of baffles within an interior of the transfer apparatus, creating individual compartments for receiving seed; the transfer apparatus includes a sensor positioned within each compartment to detect an amount of seed within each compartment; the transfer apparatus comprises an inlet port for receiving seed; a vacuum port for creating a vacuum to draw seed into the transfer apparatus; and a pivoting wall portion configured to open and release seed into the dispenser of the drum seeder assembly upon deactivation of the vacuum; the vacuum port is located at an end wall opposite the inlet port and the transfer apparatus is configured to maintain a pressurized vacuum within an open interior, wherein the pivoting wall portion is attached to a fixed wall portion by one or more hinges, and is positionable between open and closed positions to control seed flow; the transfer apparatus includes a sensor for detecting a presence of seed within the transfer apparatus, and a controller configured to control a flow of seed into the dispenser by adjusting a speed of the drum; the drum has an outer surface with a textured, adhesive, or semi-adhesive material to facilitate control over seed distribution.

In one or more aspects, such systems, methods, and/or apparatuses of the present disclosure can involve or comprise adjusting a size of a gap between the drum and the dispenser to control an amount of seed dispensed and/or a flange and bracket system allowing for vertical adjustment of the drum relative to the dispenser to modify a size of a gap between the drum and the dispenser to control an amount of seed dispensed.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a drum seeder assembly according to one or more embodiments shown and described herein;

FIG. 2 schematically depicts an enlarged view taken from FIG. 1 according to one or more embodiments shown and described herein;

FIG. 3 schematically depicts an illustrative outer surface of a drum of the drum seeder assembly of FIG. 1 according to one or more embodiments shown and described herein;

FIG. 4 schematically depicts a side view of seed flowing through the drum seeder assembly of FIG. 1 according to one or more embodiments shown and described herein;

FIG. 5 schematically depicts a perspective view of a transfer apparatus according to one or more embodiments shown and described herein;

FIG. 6 schematically depicts a side view of the transfer apparatus of FIG. 5 according to one or more embodiments shown and described herein;

FIG. 7 schematically depicts an end view of the transfer apparatus of FIG. 5 according to one or more embodiments shown and described herein;

FIG. 8 schematically depicts a cross-section view taken along line 8-8 of FIG. 7 according to one or more embodiments shown and described herein;

FIG. 9 schematically depicts a partial perspective view of the drum seeder assembly of FIG. 1 and the transfer apparatus of FIG. 5 according to one or more embodiments shown and described herein;

FIG. 10 schematically depicts a partial end view of the drum seeder assembly of FIG. 1 and the transfer apparatus of FIG. 5 according to one or more embodiments shown and described herein; and

FIG. 11 depicts a modular grow tower computing device for the drum seeder assembly according to one or more embodiments shown and described herein.

### DETAILED DESCRIPTION

Embodiments described herein are directed to systems and methods for distributing seed from a drum seeder assembly including a dispenser and a drum in which seed is dispensed through a gap formed between an open bottom end of the dispenser and the drum as the drum rotates.

Some embodiments include a drum seeder assembly and a transfer apparatus in which seed is initially deposited into the transfer apparatus. The seed may be transferred into the drum seeder assembly, and subsequently distributed out of the drum seeder assembly as the drum rotates below the dispenser. Various embodiments are described in more detail herein. Whenever possible, the same reference numerals will be used throughout the drawings to refer to the same or like parts.

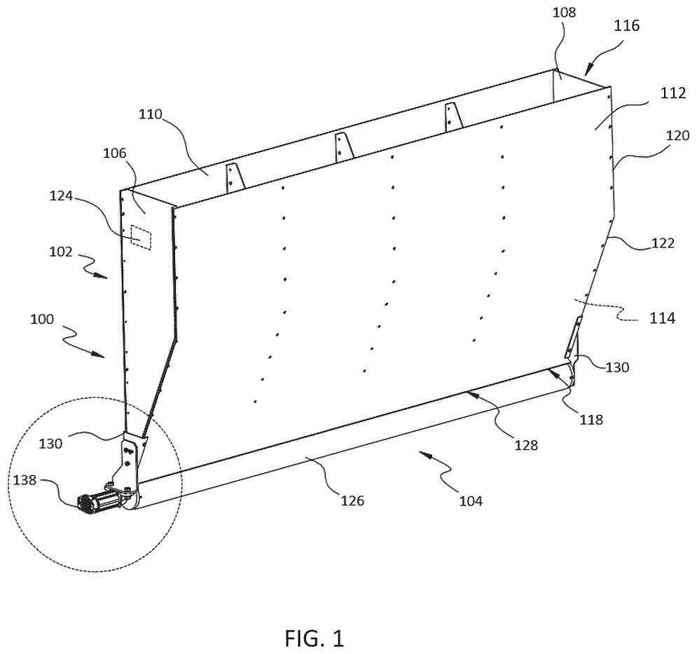

Referring now to FIG. 1, a drum seeder assembly 100 is illustrated according to one or more embodiments described herein. The drum seeder assembly 100 may generally include a dispenser 102 and a drum 104 rotatably mounted to the dispenser 102. The dispenser 102 includes a first end wall 106, a second end wall 108 opposite the first end wall 106, a first side wall 110, and a second side wall 112 opposite the first side wall 110. The first side wall 110 and the second side wall 112 extend between the first end wall 106 and the second end wall 108 and define an open interior 114. The dispenser 102 has an open top end 116, through which seed enters the open interior 114, and an open bottom end 118, through which seed is dispensed out of the open interior 114. The dispenser 102 has a length defined by a distance between the first end wall 106 and the second end wall 108, a width defined by a distance between the first side wall 110 and the second side wall 112, and a height defined by a distance between the open bottom end 118 and the open top end 116. As discussed herein, the width of the dispenser 102 along the height of the dispenser 102 may not be constant. In embodiments, the second side wall 112 of the dispenser 102 has a vertical wall portion 120 and an angled wall portion 122 relative to the vertical wall portion 120. The vertical wall portion 120 may extend parallel to the first side wall 110 and the angled wall portion 122 may extend toward the first side wall 110 such that the open bottom end 118 has a width extending between the first side wall 110 and the second side wall 112 that is less than a width of the open top end 116. Accordingly, seed entering the dispenser 102 contacts the angled wall portion 122 to accumulate at the open bottom end 118. The dispenser 102 may include a sensor 124 for detecting an amount of seed within the dispenser 102. In embodiments, the sensor 124 is located proximate the open top end 116 of the dispenser 102 to detect when the level of seed reaches a predetermined height within the open interior 114.

The drum 104 has an outer surface 126 that contacts seed falling through the open bottom end 118 of the dispenser 102. In embodiments, the outer surface 126 of the drum 104 is cylindrical. The drum 104 may also have a length extending along the entire open bottom end 118 of the dispenser 102 such that the length of the drum 104 is equal to a length of the dispenser 102 extending between the first end wall 106 and the second end wall 108. In embodiments, the drum 104 has a diameter between about 1 inch and about 20 inches. In embodiments, the drum 104 has a diameter between about 2 inches and about 10 inches. In embodiments, the drum 104 has a diameter between about 3 inches and about 6 inches. In embodiments, the drum 104 has a diameter between about 4 inches and about 5 inches. As discussed in more detail herein, the outer surface 126 of the drum 104 may have a textured, adhesive, and/or semi-adhesive surface to facilitate control over the seed falling through the open bottom end 118 and contacting the outer surface 126 of the drum 104.

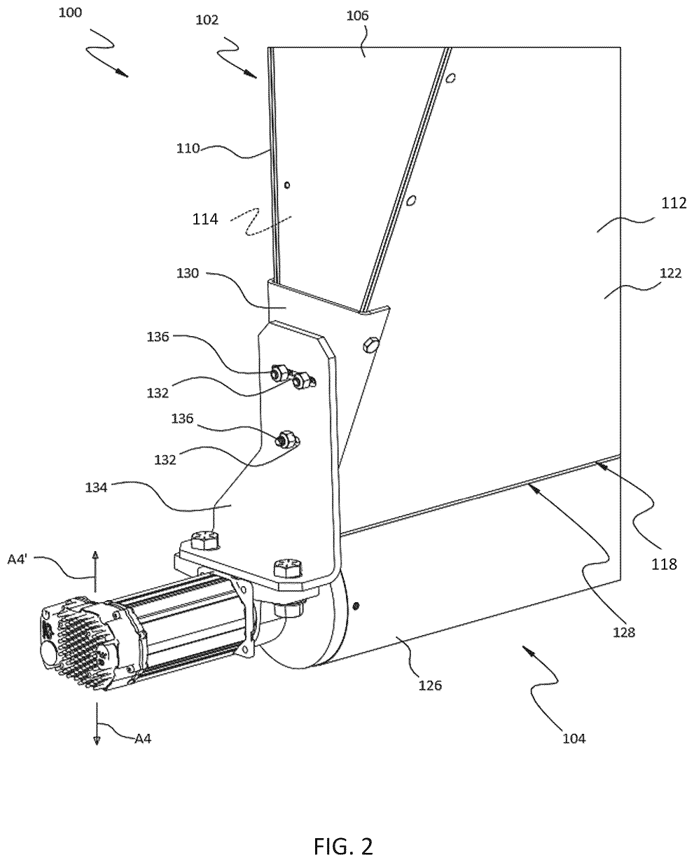

Referring now to FIG. 2, an enlarged view of the drum 104 being mounted to the dispenser 102 at the open bottom end 118 of the dispenser 102 is illustrated. It should be appreciated that the drum 104 is a cylindrical member rotatably mounted at the open lower end of the dispenser 102 in a spaced apart manner so as to provide a gap 128 between the open lower end and the drum 104, defined by a distance between the drum 104 and the angled wall portion 122 of the dispenser 102. As described in more detail herein, the gap 128 allows for a predetermined amount of seed to exit the dispenser 102. In embodiments, the size of the gap, i.e., the distance between the drum 104 and the angled wall portion 122 of the dispenser 102 is between about 0.005 inches and about 2 inches. In embodiments, the size of the gap 128 is between about 0.01 inches and about 1 inch. In embodiments, the size of the gap 128 is between about 0.02 inches and about 0.75 inches. It should also be appreciated that, as discussed herein, the size of the gap 128 may be adjustable between about 0.005 inches and about 2 inches, depending on the type of seed being utilized. As one of ordinary skill in the art will recognize, these dimensions may change, depending on the average size, e.g., diameter, of seed, the size, e.g., diameter, of largest seed, the texture of seed, the weight of seed, the shape of seed, and/or based on other factors.

An end bracket 130 is fixed at each end of the dispenser 102 and includes a plurality of holes 132. A flange 134 is provided at each end of the drum 104 and mounted to the end bracket 130 to mount the drum 104 below the open bottom end 118 of the dispenser 102. As shown, a plurality of fasteners 136 extend through the flange 134 and the end bracket 130 for fixing the drum 104 to the dispenser 102. In embodiments, the holes 132 formed in the end bracket 130 are elongated to extend in a vertical direction, i.e., from the open bottom end 118 toward the open top end 116. This permits the drum 104 to be translated closer to or further from the dispenser 102 to decrease or increase the distance between the drum 104 and the dispenser 102, respectively. By doing so, the size of the gap 128 formed between the drum 104 and the dispenser 102 may be adjusted to control the amount of seed exiting the dispenser 102 at any given time. A motor 138 is provided at an end of the drum 104 and may be mounted to the flange 134. A controller (not shown) may be provided for operating the motor 138 and, thus, the speed at which the drum 104 rotates. In embodiments, the drum 104 rotates at a speed between about 1 reps per minute (rpm) and about 100 rpm. In embodiments, the drum 104 rotates at a speed between about 1 rpm and about 50 rpm. In embodiments, the drum 104 rotates at a speed between about 10 rpm and about 30 rpm. In addition, the motor 138 may include a translation mechanism (not shown), operated by the controller, that may be operated to control translation of the drum 104 relative to the dispenser 102. Specifically, operation of the translation mechanism of the motor 138 will cause the flange 134 to move relative to the end bracket 130 to raise or lower the drum 104 relative to the dispenser 102. In embodiments, the translation mechanism may include any suitable device such as a rack and pinion gear assembly, track, or the like to permit the drum 104 to move in a vertical direction closer to or further from the open bottom end 118 of the dispenser 102 and adjust the size of the gap 128 formed therebetween. In embodiments, operation of the translation mechanism causes the flange 134 to move relative to the end bracket 130 due to the holes 132 being elongated and the fasteners 136 permitted to move from a lower end of the holes 132 toward an upper end of the holes 132.

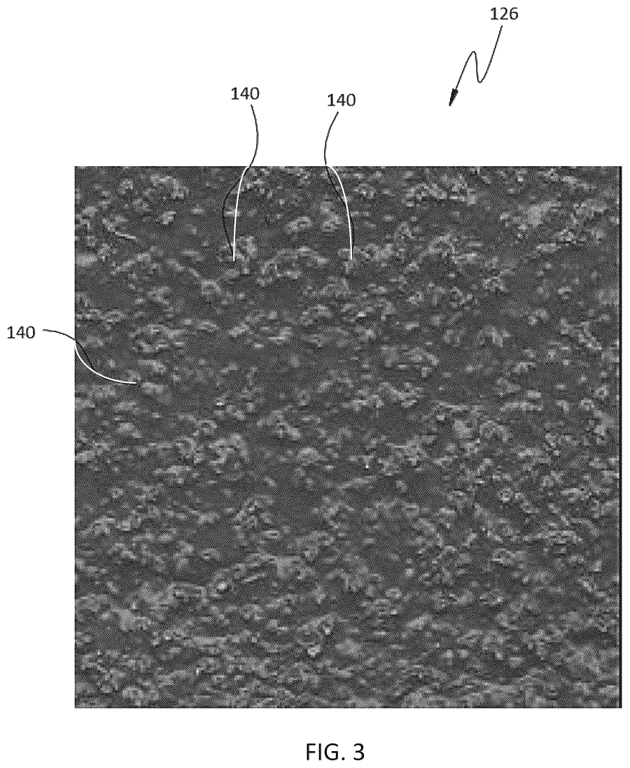

Referring now to FIG. 3, an illustrative outer surface 126 of the drum 104 is shown. In embodiments, the outer surface 126 of the drum 104 has a plurality of protrusions 140 extending in a radial direction therefrom. In embodiments, the protrusions 140 have a diameter ranging from about 0.001 inches and about 0.1 inches. In embodiments, the protrusions 140 have a diameter ranging from about 0.005 inches and about 0.08 inches. In embodiments, the protrusions 140 have a diameter ranging from about 0.005 inches and about 0.06 inches. In embodiments, the protrusions 140 have a height extending radially from the drum 104 ranging from about 0.0005 inches and about 0.1 inches. In embodiments, the protrusions 140 have a height ranging from about 0.001 inches and about 0.08 inches. In embodiments, the protrusions 140 have a height ranging from about 0.001 inches and about 0.05 inches. The number of protrusions 140 per square inch also effect the coefficient of friction of the outer surface 126. In embodiments, one square inch of the outer surface 126 includes between about 20 and about 300 protrusions 140. In embodiments, one square inch of the outer surface 126 includes between about 30 and about 250 protrusions 140. In embodiments, one square inch of the outer surface 126 includes between about 40 and about 200 protrusions 140. As discussed in more detail herein, the outer surface 126 has a coefficient of friction such that the protrusions 140 allow for increased gripability of the seed in contact with the drum 104 as the drum 104 rotates below the open bottom end 118. It should be appreciated that an increase in a size, i.e., a radial height, of the protrusions 140 as well as the number of protrusions 140 on the outer surface 126 of the drum 104 may contribute to an increased coefficient of friction and, thus, increased gripability. In embodiments, the outer surface 126 may be integrally formed with the drum 104 as a monolithic structure. In other embodiments, the outer surface 126 may be a separate surface material that is conformed to fit around an exterior of the drum 104 and fixed thereto. For example, the surface material may be painted onto the exterior of the drum 104 or may be a rubberized material cut to size and formed around the exterior of the drum 104. The surface material used herein may be a well-known material or some other yet to be developed rubberized material such as those used to treat boats and docks. Accordingly, the surface material has non-slip properties. In embodiments, the surface material comprises a copolymer, an acrylic, a urethane, a rubber, or any combination thereof. In embodiments, the surface material comprises a foam roller, a fabric, a bristle brush, or any combination.

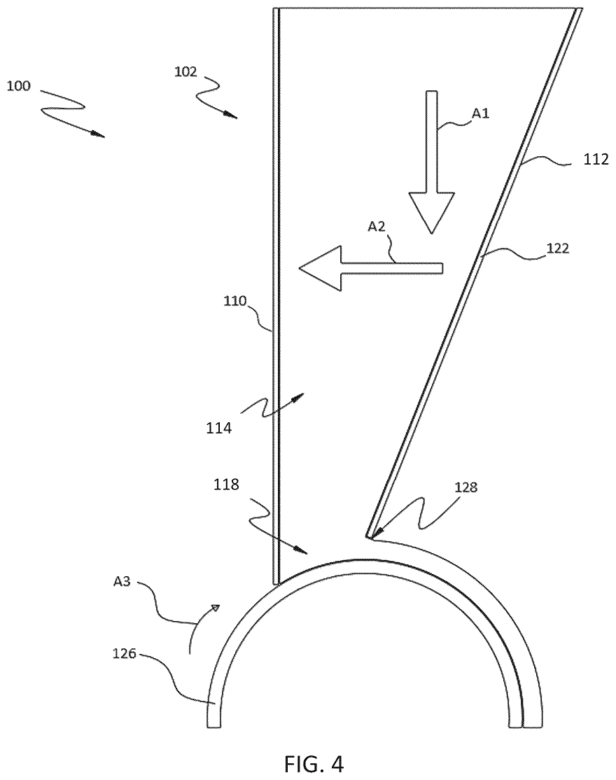

Referring now to FIG. 4, operation of the drum seeder assembly 100 is illustrated in which seed is dispensed out of the dispenser 102. Specifically, seed enters the dispenser 102 through the open top end 116. The manner in which seed is provided into the dispenser 102 is disclosed in more detail herein. As seed enters the dispenser 102, the seed falls toward the open bottom end 118 along the direction of arrow A1, some of which contacts the angled side wall portion of the second side wall 112. Seed may be deflected off of the angled side wall portion generally along the direction of arrow A2, which funnels the seed toward the more narrow open bottom end 118 of the dispenser 102. In embodiments, the size of the gap 128 formed between the open lower end and the outer surface 126 of the drum 104 is such that seed accumulates at the open lower end of the dispenser 102 and the pressure created by the accumulated seed prevents seed from moving through the open lower end and out of the dispenser 102. Thus, seed is drawn out of the dispenser 102 as the drum 104 rotates in the direction of arrow A3.

More particularly, as the drum 104 rotates in the direction in the direction of arrow A3, the outer surface 126 of the drum 104 grips a layer of seed within the gap 128 in contact with the outer surface 126 of the drum 104 and draws the layer of seed out of the dispenser 102. Rather, than the seed being forcefully ejected from the dispenser 102 by the rotation of the drum 104, the outer surface 126 of the drum 104 grips the layer of seed in contact therewith. Once the seed rotates to a lower point of the drum 104, the force of gravity outweighs the friction force of the outer surface 126 of the drum 104 gripping the seed and the seed is permitted to fall from the drum 104 into a receiving area, such as a seed receiving cart (not shown). It should be appreciated that the amount of seed that is drawn from the dispenser 102 by the drum 104 is dependent on a number of factors including, but not limited to, the diameter of the seed, the size of the gap 128, the speed at which the drum 104 rotates, and the gripability of the outer surface 126 of the drum 104.

For example, to increase the rate at which seed exits the dispenser 102, the diameter of seed, which may be determined by an average diameter of a total supply of the seed, may be reduced, the size of the gap 128 may be increased, the speed at which the drum 104 rotates may be increased, and/or the gripability of the outer surface 126 of the drum 104 may be increased. More particularly, to increase the size of the gap 128, a signal is transmitted from the controller to the translation mechanism to move the drum 104 in a first vertical direction away from the dispenser 102 in the direction of arrow A4. To increase the speed at which the drum 104 rotates, a signal is transmitted from the controller to the motor 138 instructing the motor 138 to increase the rotational speed, thereby increasing the rotational speed of the drum 104. To increase the gripability of the outer surface 126 of the drum 104, the height of the protrusions 140 or the number of protrusions 140 may be increased. Alternatively or in addition thereto, the surface material forming the outer surface 126 of the drum 104 may be a material having a higher coefficient of friction.

Similarly, to decrease the rate at which seed exits the dispenser 102, the diameter, or average diameter, of seed may be increased, the size of the gap 128 may be decreased, the speed at which the drum 104 rotates may be decreased, and/or the gripability of the outer surface 126 of the drum 104 may be decreased. More particularly, to decrease the size of the gap 128, a signal is transmitted from the controller to the translation mechanism to move the drum 104 in a second vertical direction, opposite the first vertical direction, toward the dispenser 102 in the direction of arrow A4′. To decrease the speed at which the drum 104 rotates, a signal is transmitted from the controller to the motor 138 instructing the motor 138 to decrease the rotational speed, thereby decreasing the rotational speed of the drum 104. To decrease the gripability of the outer surface 126 of the drum 104, the height of the protrusions 140 or the number of protrusions 140 may be decreased. Alternatively or in addition thereto, the surface material forming the outer surface 126 of the drum 104 may be a material having a lower coefficient of friction. It should be appreciated that the size of the gap 128 and/or the rate at which the drum 104 rotates may be adjusted based on the diameter of the seed.

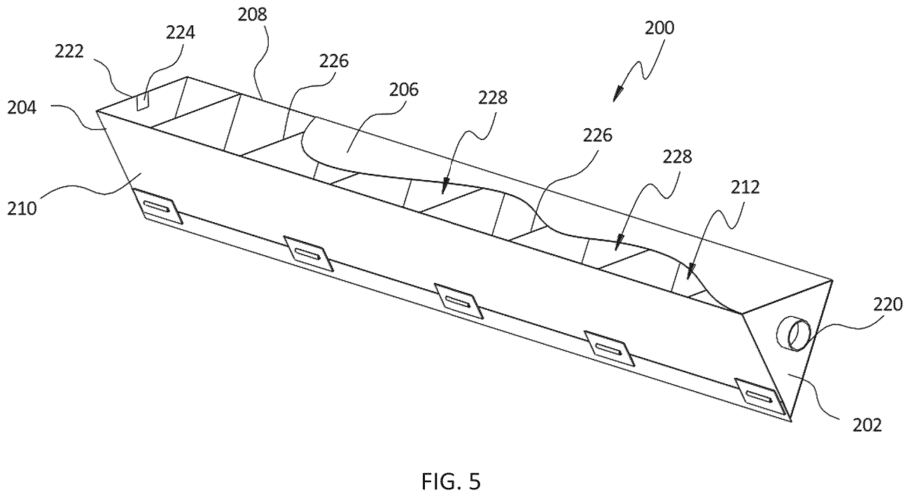

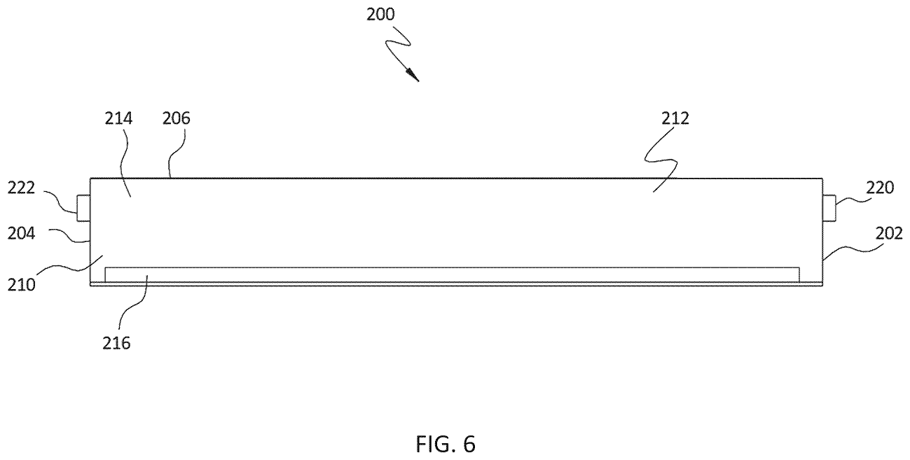

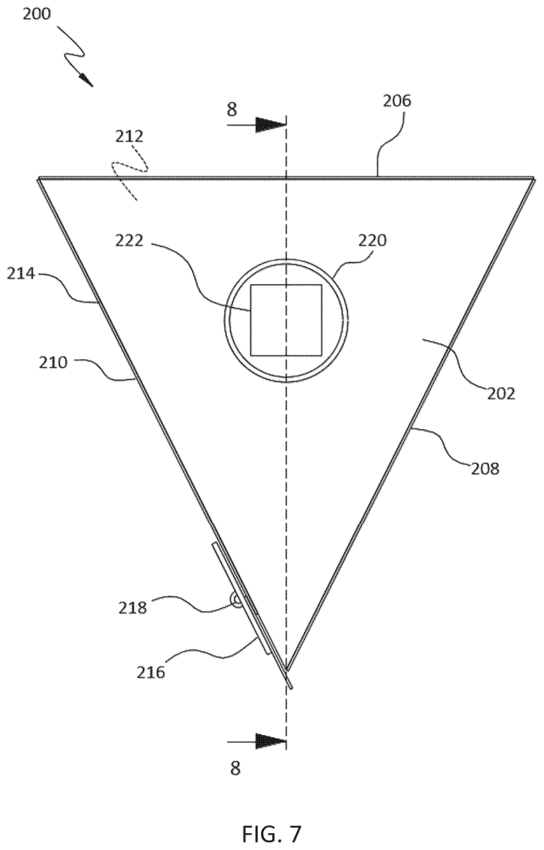

Referring now to FIGS. 5-7, a transfer apparatus 200 is illustrated. As discussed herein, the transfer apparatus 200 is utilized for transferring seed to the drum seeder assembly 100. The transfer apparatus 200 includes a first end wall 202 and a second end wall 204 opposite the first end wall 202, a top wall 206, a first side wall 208, and a second side wall 210 opposite the first side wall 208. The top wall 206, the first side wall 208, and the second side wall 210 extend between the first end wall 202 and the second end wall 204 and define an open interior 212. The transfer apparatus 200 has a length defined by a distance between the first end wall 202 and the second end wall 204, a width defined by a distance between the first side wall 208 and the second side wall 210, and a height defined by a distance between the top wall 206 and lower point, such as a point of contact between the first side wall 208 and the second side wall 210. As discussed herein, the width of the transfer apparatus 200 may not be constant along the height of the transfer apparatus 200. The transfer apparatus 200 may have any suitable geometry for housing seed. In embodiments, as shown, the transfer apparatus 200 has a triangular cross-section geometry such that the width of the transfer apparatus 200 at the top wall 206 is greater than the width of the transfer apparatus 200 opposite the top wall 206. However, the transfer apparatus 200 may have other geometries such as a cylindrical cross-section, a rectangular cross-section, and the like.

In embodiments, the second side wall 210 includes a fixed wall portion 214 and a pivoting wall portion 216 pivotally attached to the fixed wall portion 214. The fixed wall portion 214 extends from the top wall 206 of the transfer apparatus 200 and extends from the first end wall 202 to the second end wall 204. The pivoting wall portion 216 is pivotally attached to the fixed wall portion 214 by one or more hinges 218. As shown a plurality of spaced apart hinges 218 are provided for pivotally attaching the pivoting wall portion 216 to the fixed wall portion 214. The pivoting wall portion 216 is positionable between a closed position, as shown in FIG. 5, and an open position. When the pivoting wall portion 216 is in the closed position, seed is maintained within the open interior 212. Specifically, a seal is formed between the pivoting wall portion 216 and each of the first end wall 202, the second end wall 204, and the first side wall 208. When the pivoting wall portion 216 is in the open position, the pivoting wall portion 216 is pivoted away from the first side wall 208 about the hinges 218 and the seed within the open interior 212 is able to fall through an opening formed between the pivoting wall portion 216 of the second side wall 210 and the first side wall 208.

The transfer apparatus 200 includes an inlet port 220 formed at the first end wall 202 proximate the top wall 206 and a vacuum port 222 formed at the second end wall 204 proximate the top wall 206. Seed may be fed into the transfer apparatus 200 through the inlet port 220 by a seed reservoir (not shown). A vacuum source (not shown) may be in fluid communication with the vacuum port 222 such that air may be removed from the open interior 212 of the transfer apparatus 200 to maintain a pressurized vacuum within the open interior 212. As discussed in more detail herein, the vacuum created within the open interior 212 of the transfer apparatus 200 causes the pivoting wall portion 216 to be kept in the closed position. The vacuum created within the open interior 212 also draws seed entering the transfer apparatus 200 toward the vacuum port 222. Once the vacuum source is deactivated, the pivoting wall portion 216 is released and pivots toward the open position to permit seed to exit the transfer apparatus 200. The transfer apparatus 200 may include one or more sensors 224 for detecting the presence of seed within the open interior 212.

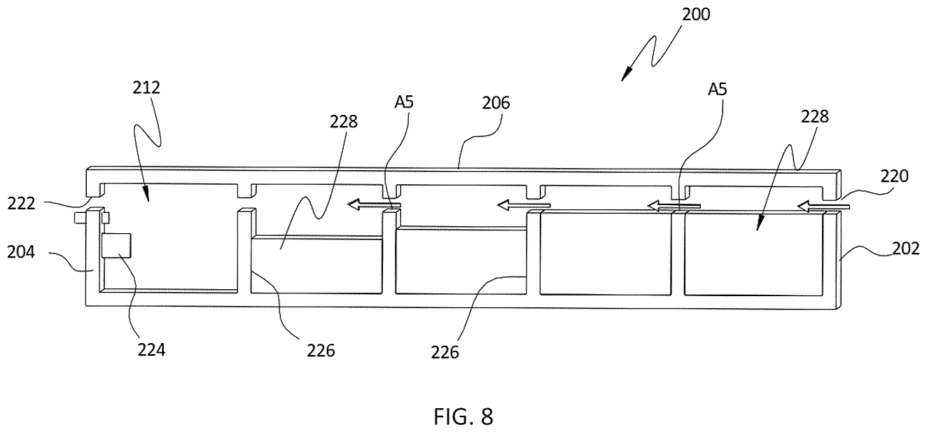

Referring now to FIGS. 5 and 8, in embodiments, the transfer apparatus 200 has a plurality of baffles 226 arranged in a spaced apart manner within the open interior 212 thereof. It should be appreciated that each baffle 226 has a geometry corresponding to a geometry defined by the first side wall 208, the second side wall 210, and the top wall 206 of the transfer apparatus 200. Thus, in the present embodiment, each baffle 226 has a triangular geometry, as shown in FIG. 5. A shown, the transfer apparatus 200 includes seven baffles 226 defining eight individual compartments 228 for receiving seed. As discussed in more detail herein, the separate compartments 228 ensure a distributed deposit of seed into the dispenser 102 of the drum seeder assembly 100. As noted above, the vacuum created within the open interior 212 causes seed to be drawn from the inlet port 220 toward the vacuum port 222. Thus, seed initially fills the compartment 228 closest to the inlet port 220. Once the compartment 228 closest to the inlet port 220 is filled, seed flows into a subsequent compartment 228 in the direction of arrows A5 and the process repeats until each compartment 228 is filled with the compartment 228 closest to the vacuum port 222 being the last compartment 228 to be filled with seed. In embodiments, the transfer apparatus 200 includes a sensor 224 within only the last compartment 228 closest to the vacuum port 222 to determine when seed is received within each of the compartments 228. In embodiments, a sensor 224 is positioned within each of the compartments 228 to detect the amount of seed within each compartment 228.

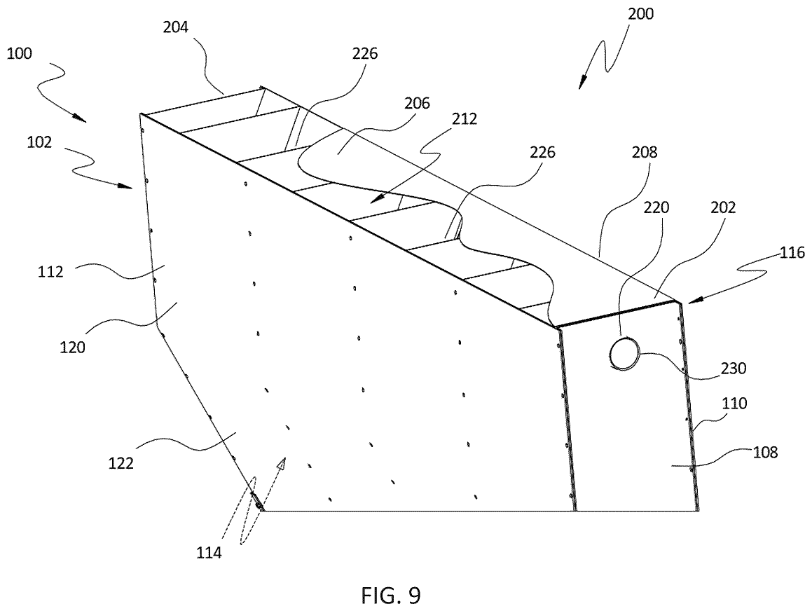

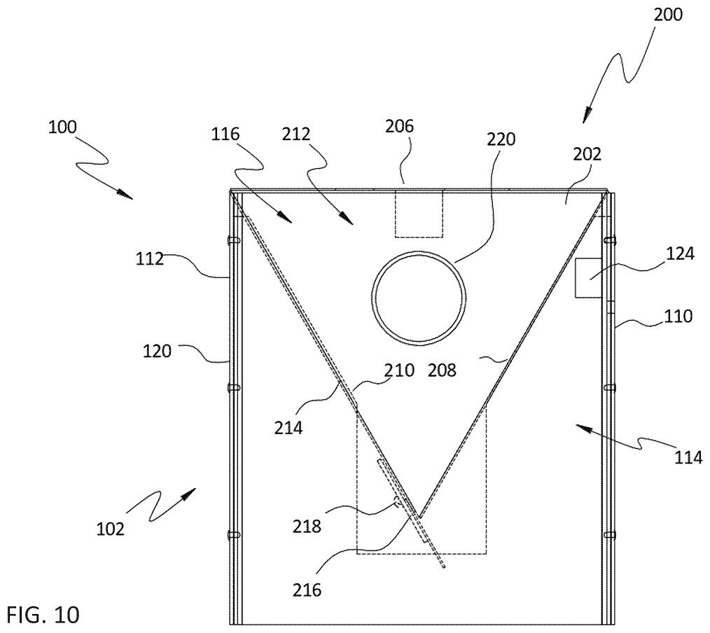

Referring now to FIGS. 9 and 10, the transfer apparatus 200 is illustrated as being positioned within the drum seeder assembly 100 discussed herein. Specifically, the transfer apparatus 200 extends through the open top end 116 of the dispenser 102 of the drum seeder assembly 100 to be positioned within the open interior 114 of the dispenser 102. In this embodiment, a receiving hole 230 may be formed in each end wall of the dispenser 102 to receive a corresponding one of the inlet port 220 and the vacuum port 222 of the transfer apparatus 200. Thus, once the transfer apparatus 200 receives a required amount of seed, as detected by the one or more sensors 124, 224 within the transfer apparatus 200, the vacuum source in communication with the transfer apparatus 200 may be deactivated such that the pivoting wall portion 216 is permitted to rotate to the open position. Once the pivoting wall portion 216 moves to the open position, the seed is released into the open interior 114 of the dispenser 102.

As discussed herein, the dispenser 102 may include a sensor 124, 224 for detecting the presence of seed within the dispenser 102. Thus, upon the sensor 124 detecting the presence of seed above a predetermined threshold, the sensor 124 may transmit a signal to reactivate the vacuum supply to close the pivoting wall portion 216, thereby preventing additional seed from entering the dispenser 102. In other embodiments, the vacuum source may be instructed to only be deactivated for a predetermined period of time to permit the pivoting door portion to only be in the open portion for a specific amount of time. The predetermined period of time which the vacuum supply is deactivated for may be determined based on the amount of seed within the dispenser 102 and/or the transfer apparatus 200, the rate at which seed enters the dispenser 102 from the transfer apparatus 200, or any other suitable factors to prevent overfilling of the dispenser 102.

From the above, it is to be appreciated that defined herein is a system for distributing seed from a drum seeder assembly including a dispenser and a drum in which seed is dispensed through a gap formed between an open bottom end of the dispenser and the drum as the drum rotates.

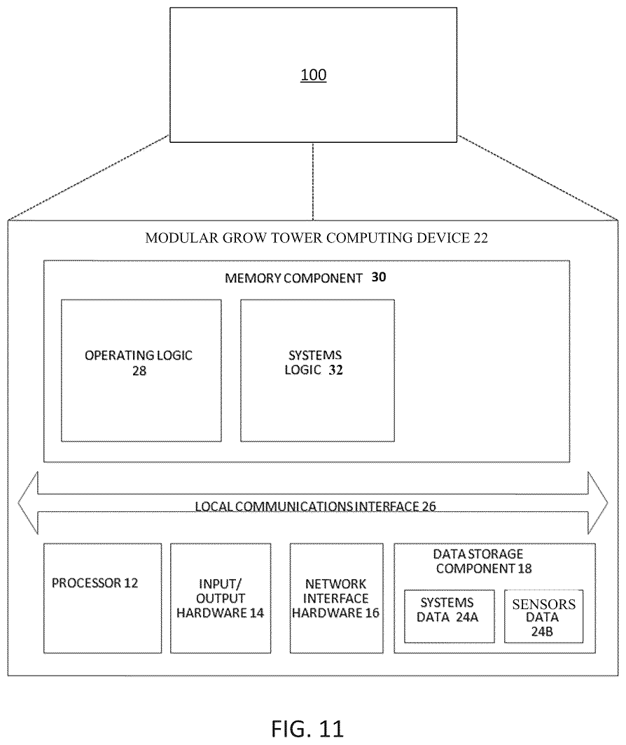

FIG. 11 illustrates a computing “controller” device 22, according to embodiments described herein. As discussed above, the modular grow tower computing device 22 includes a memory component 30, a processor 12, input/output hardware 14, network interface hardware 16, and a data storage component 18 (which stores systems data 24A, sensor data 24B, and/or other data). Each of the components of the modular grow tower computing device 22 may be communicatively coupled to a local communications interface 26. The local communications interface 26 is generally not limited by the present disclosure and may be implemented as a bus or other communications interface to facilitate communication among the components of the modular grow tower computing device (e.g., processor) coupled thereto.

The memory component 30 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), Blu-Ray discs, and/or other types of non-transitory computer-readable mediums. Depending on the particular embodiment, these non-transitory computer-readable mediums may reside within or outside the modular grow tower computing device 22. The memory component 30 may store, for example, operating logic 28 and the systems logic 32. The operating logic 28 and the systems logic 32 may each include a plurality of different pieces of logic, each of which may be embodied as a computer program, firmware, and/or hardware, as an example.

The operating logic 28 may include an operating system and/or other software for managing components of the modular grow tower computing device 22. As discussed above, the systems logic 32 may reside in the memory component 30 and may be configured to perform the functionality, as described above. In some embodiments, the systems logic 32 may reside on different modular grow tower computing devices. As an example, one or more of the functionalities and/or components described herein may be provided by a user modular grow tower computing device and/or remote modular grow tower computing device. While the modular grow tower computing device 22 is illustrated with the systems logic 32 as separate logical components, this is only an example. In some embodiments, a single piece of logic (and/or several linked modules) may cause the modular grow tower computing device 22 to provide the described functionality.

The processor 12 may include any processing component operable to receive and execute instructions (such as from the data storage component 18 and/or the memory component 30a). Illustrative examples of the processor 12 include, but are not limited to, a computer processing unit (CPU), a many integrated core (MIC) processing device, an accelerated processing unit (APU), a digital signal processor (DSP). In some embodiments, the processor 12 may be a plurality of components that function together to provide processing capabilities, such as integrated circuits (including field programmable gate arrays (FPGA)) and the like.

The input/output hardware 14 may include and/or be configured to interface with microphones, speakers, a display, and/or other hardware. That is, the input/output hardware 14 may interface with hardware that provides a user interface or the like. The user interface may include a graphical user interface (GUI) comprising various interactive elements such as buttons, menus, display graphs, icons, sliders, and text fields. The GUI is designed to facilitate user interaction with the system, providing visual representations of data and controls to improve the overall usability and efficiency of the system. The graphical elements may be arranged in a layout that is intuitive and accessible, allowing users to navigate the interface and perform desired actions with ease.

The network interface hardware 16 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the modular grow tower computing device 22 and other modular grow tower computing devices, such as a user modular grow tower computing device, a remote modular grow tower computing device, and/or other devices.

The data storage component 18 may generally be any medium that stores digital data, such as, for example, a hard disk drive, a solid state drive (SSD), a compact disc (CD), a digital versatile disc (DVD), a Blu-Ray disc, and/or the like. It should be understood that the data storage component 18 may reside local to and/or remote from the modular grow tower computing device 22 and may be configured to store one or more pieces of data and selectively provide access to the one or more pieces of data.

It should be understood that while the components in FIG. 11 are illustrated as residing within the modular grow tower computing device 22, this is merely an example. In some embodiments, one or more of the components may reside external to the modular grow tower computing device 22. It should also be understood that, while the modular grow tower computing device 22 is illustrated as a single device, this is also merely an example. That is, the modular grow tower computing device 22 may represent a plurality of devices that are communicatively coupled to one another and provide the functionality described herein.

Additionally, while the modular grow tower computing device 22 is illustrated with the various logic components (e.g., the operating logic 28 and the systems logic 32) and data components (e.g., the systems data 24A, sensors data 24B) as separate components, this is also an example. In some embodiments, a single piece of logic (and/or a plurality of linked modules) and/or a single data component (and/or a plurality of linked modules) may also cause the modular grow tower computing device 22 to provide the functionality described herein.

Similarly, while the modular grow tower computing device 22 is depicted in a “PC” environment, it should be understood that at least some embodiments may not be limited in this way. Specifically, some embodiments may be configured such that the modular grow tower computing device 22 is configured as and/or includes a programmable logic controller (PLC) and/or other computing infrastructure.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for distributing seed comprising:
a drum seeder assembly including:
a dispenser with an open top end for receiving seed, and an open bottom end for dispensing seed;
a drum rotatably mounted beneath the dispenser, configured to receive seed through the open bottom end and distribute the seed as the drum rotates; and
a transfer apparatus for delivering seed to the drum seeder assembly.

2. The system of claim 1, wherein the dispenser further comprises a sensor proximate to the open top end for detecting an amount of seed within the dispenser.

3. The system of claim 1, wherein the drum seeder assembly further comprises:
a motor for rotating the drum; and
a controller configured to control a flow of seed into the dispenser by adjusting a speed of the drum.

4. The system of claim 1, wherein the transfer apparatus comprises a plurality of baffles within an interior of the transfer apparatus, creating individual compartments for receiving seed.

5. The system of claim 4, wherein the transfer apparatus includes a sensor positioned within each compartment to detect an amount of seed within each compartment.

6. The system of claim 1, wherein the transfer apparatus comprises an inlet port for receiving seed; a vacuum port for creating a vacuum to draw seed into the transfer apparatus; and a pivoting wall portion configured to open and release seed into the dispenser of the drum seeder assembly upon deactivation of the vacuum.

7. The system of claim 6, wherein the vacuum port is located at an end wall opposite the inlet port and the transfer apparatus is configured to maintain a pressurized vacuum within an open interior, wherein the pivoting wall portion is attached to a fixed wall portion by one or more hinges, and is positionable between open and closed positions to control seed flow.

8. A method for distributing seed comprising:
depositing seed into a transfer apparatus;
transferring the seed from the transfer apparatus into a dispenser of a drum seeder assembly; and
dispensing the seed through an open bottom end of the dispenser as a drum rotatably mounted beneath the dispenser rotates.

9. The method of claim 8, further comprising adjusting a size of a gap between the drum and the dispenser to control an amount of seed dispensed.

10. The method of claim 8, wherein the transfer apparatus includes a sensor for detecting a presence of seed within the transfer apparatus, and a controller configured to control a flow of seed into the dispenser by adjusting a speed of the drum.

11. The method of claim 10, wherein the transfer apparatus further comprises a plurality of baffles within an interior of the transfer apparatus, creating individual compartments for receiving seed.

12. The method of claim 11, wherein individual sensors are positioned within each compartment to detect an amount of seed within each compartment.

13. A drum seeder assembly comprising:
a dispenser with first and second end walls, first and second side walls, an open top end, and an open bottom end; and
a drum with a cylindrical outer surface, rotatably mounted to the dispenser, configured to dispense seed through a gap formed between the drum and the open bottom end of the dispenser as the drum rotates.

14. The drum seeder assembly of claim 13, wherein the drum has an outer surface with a textured, adhesive, or semi-adhesive material to facilitate control over seed distribution.

15. The drum seeder assembly of claim 13, further comprising a flange and bracket system allowing for vertical adjustment of the drum relative to the dispenser to modify a size of a gap between the drum and the dispenser to control an amount of seed dispensed.
